(19) United States
(12) Patent Application Publication
(10) Pub. No.: US 2010/0085658 A1
(43) Pub. Date: Apr. 8, 2010

(54) STORAGE DEVICE CONTROLLING DEVICE, STORAGE DEVICE, STORAGE DEVICE CONTROLLING PROGRAM, AND STORAGE DEVICE CONTROLLING METHOD

(75) Inventors: Yoshiki Fushimi, Kawasaki (JP); Takeshi Ueda, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/568,393

(22) Filed: Sep. 28, 2009

Related U.S. Application Data
(63) Continuation of application No. PCT/JP2007/056881, filed on Mar. 29, 2007.

(51) Int. Cl. G11B 21/02

(52) U.S. Cl. 360/75; G9B/21.003

(57) ABSTRACT

A storage device controlling device includes: a head sector generation section that creates predetermined information different from control information to be read out first from plural storage media; an input/output section that writes the control information into a head sector on the storage media; a reception section that receives an access request from outside; and a conversion section that converts a first sector number as a sector number on the plural storage media into a second sector number as a sector number other than that of the head sector on the plurality of storage media, based on a predetermined conversion method, the first sector number being designated by the access request, and the input/output section further accesses the plural storage media at the second sector number.

### CROSS-REFERENCE TO RELATED APPLICATIONS

This application is a continuation application, filed under 35 U.S.C.§111(a), of PCT Application No. PCT/JP2007/056881, filed Mar. 29, 2007, the disclosure of which is herein incorporated in its entirety by reference.

### FIELD

The embodiment of the present invention relates to a storage device controlling device, a storage device, a storage device controlling program, and a storage device controlling method for controlling plural storage media.

### BACKGROUND

A disc array system is a system which makes magnetic disc devices redundant, aiming for prevention of data loss caused by a malfunctions occurring in the magnetic disc devices. In computers which need high reliability in use as servers, magnetic disc devices are made redundant (RAID1) by a disc array control device. Therefore, data on magnetic discs is not lost even when a malfunction occurs in one of the magnetic disc devices.

FIG. 9 depicts a configuration of a disc array system. The disc array system 200 includes a disc array control device 1 additionally mounted on a magnetic disc control device 101 mounted on a system board 110. The magnetic disc control device 101 controls data inputted to or outputted from magnetic disc devices 130A and 130B. The disc array control device 1 operates controls of the disc array that relates to redundancy. A software section 120 includes an OS (Operating System) and an application program, and accesses the disc array system 200.

When the disc array control device operates normally, the disc array control device 1 causes the OS to recognize the magnetic disc devices 130A and 130B to be a logically single magnetic disc device, by duplexing the magnetic disc devices 130A and 130B as depicted in FIG. 9. As a result, the OS writes the same data into two magnetic disc devices 130A and 130B through the magnetic disc control device 101. Therefore, even when one of the magnetic disc devices causes a malfunction, data is not lost insofar as the other one of the magnetic disc devices operates normally. The array depicted in FIG. 9 expresses that data A(0), A(1), . . . are stored in sector units. In this array, a sector in which A(0) is stored is a head sector. Subsequent to the head sector, the sector number increases as A(1), A(2), . . . , as sectors increase. Further, A(0) is system startup information which is required for starting up the system.

If BIOS 100 recognizes presence of the disc array control device 1, the disc array control device 1 is selected as an input/output control device to/from the magnetic disc devices 130A and 130B. Otherwise, if absence of the disc array control device 1 is recognized, the magnetic disc control device 101 is directly used as an input/output control device to/from the magnetic disc devices 130A and 130B. The OS recognizes the magnetic disc devices 130A and 130B respectively as two magnetic disc devices which are not duplexed.

The following technique has been disclosed.

### [Patent Document 1] Japanese Laid-Open Patent Publication No. 06-332624

When the disc array control device 1 becomes not operational due to a malfunction or poor contact caused by mismounting, the BIOS 100 determines that the disc array control device 1 does not exist. Accordingly, the magnetic disc devices 130A and 130B are recognized as two individual disc devices which are not duplexed. That is, data in the magnetic disc device 130A is updated (e.g., data A(1), A(2), . . . , in the magnetic disc device 130A in FIG. 9 are updated to data B(1), B(2), . . . ), since the magnetic disc device 130A is recognized as the same magnetic disc device as that when a disc array was in the normal condition. Data in the other magnetic disc device 130B is not updated since the other magnetic disc device 130B is recognized as a different magnetic disc device which is newly added to the system. Even if the disc array control device 1 is not recognized, disc access to the magnetic disc device 130A takes place through the magnetic disc control device 101.

Thereafter, as depicted in FIG. 11, if the disc array control device 1 is recovered by replacement and if the two magnetic disc devices 130A and 1308 are then treated as one set of duplexed magnetic disc devices, the OS treats un-updated data on the magnetic disc device 1308 as the latest data. Therefore, a contradiction occurs in the system, and causes a trouble such as system down or inability to start up the system. Further, a trouble occurs in a file system, and data on the magnetic discs may be lost.

### SUMMARY

According to an aspect of the present invention, there is provided a storage device controlling device for controlling a storage device having a plurality of storage media, including: a head sector write section that writes predetermined information into a head sector on each of the plurality of storage media, the predetermined information being different from control information to be read out first from the plurality of storage media; and an access section that, if an access request is received from outside, converts a first sector number as a sector number on the plurality of storage media into a second sector number as a sector number other than that of the head sector on the plurality of storage media, based on a predetermined conversion method, and accesses the plurality of storage media at the second sector number, the first sector number being designated by the access request.

According to another aspect of the present invention, there is provided a storage device having a plurality of storage media, including: a head sector write section that writes predetermined information into a head sector on each of the plurality of storage media, the predetermined information being different from control information to be read out first from the plurality of storage media; and an access section that, if an access request is received from outside, converts a first sector number as a sector number on the plurality of storage media into a second sector number as a sector number other than that of the head sector on the plurality of storage media, based on a predetermined conversion method, and accesses the plurality of storage media at the second sector number, the first sector number being designated by the access request.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram that depicts an example of functions of a disc array control device according to a first embodiment;

FIG. 2 is a block diagram depicting an example of a system configuration including a disc array control device according to the embodiment;

FIG. 3 is a flowchart depicting initializing processing of a disc array control device according to the first embodiment;

FIG. 4 is a flowchart depicting system startup processing of the disc array control device according to the embodiments;

FIG. 5 is a flowchart depicting sector number conversion processing of the disc array control device according to the first embodiment;

FIG. 6 is a functional block diagram depicting an example of functions of the disc array control device according to a second embodiment;

FIG. 7 is a flowchart depicting initializing processing of the disc array control device according to the second embodiment;

FIG. 8 is a flowchart depicting sector number conversion processing of the disc array control device according to the second embodiment;

FIG. 9 is a block diagram depicting an example of a configuration of a disc array system including a disc array control device;

FIG. 10 illustrates a behavior of a system when a malfunction occurs in a disc array control device; and

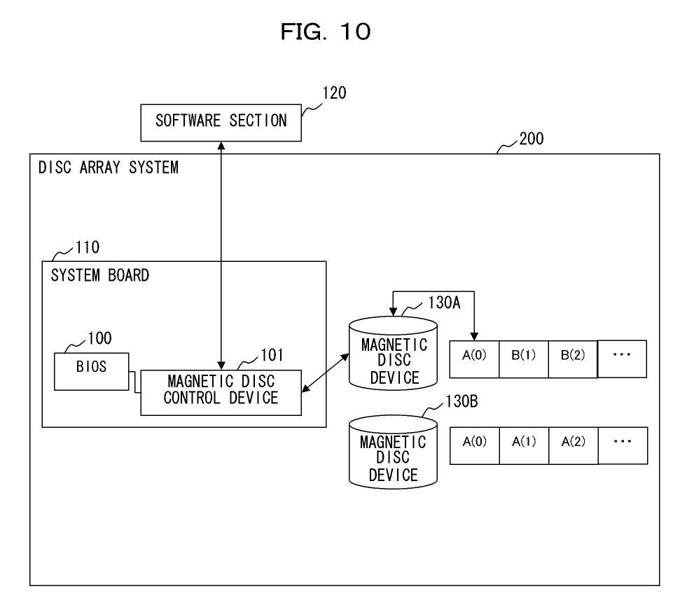

FIG. 11 illustrates a behavior of the system when recovering the disc array control device.

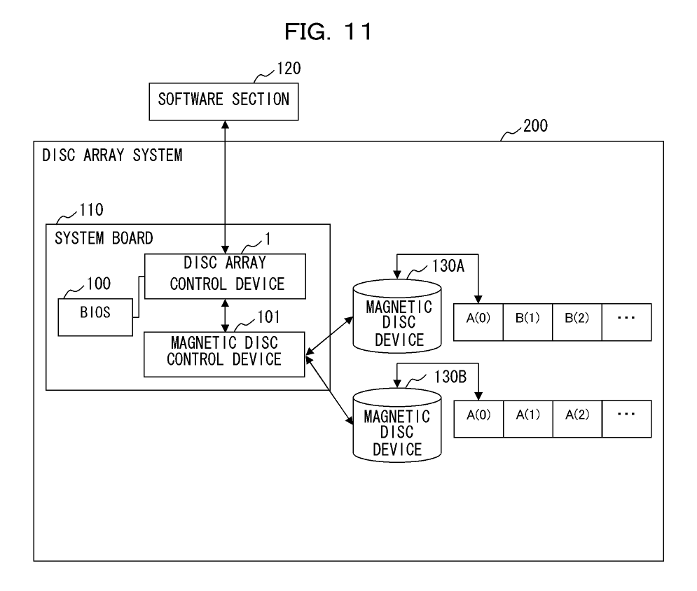

### DESCRIPTION OF EMBODIMENTS

The embodiments has been made to solve problems described above and has an object of providing a storage device controlling device, a storage device, a storage device controlling program, and a storage device controlling method, which prevent abnormal operation when no storage device controlling device is recognized.

### First Embodiment

An embodiment will be described with reference to a disc array control device to which a storage device controlling device and a storage device according to an aspect of the present invention are applied. In the present embodiment, the disc array control device is provided in a computer.

Prior to descriptions of the present embodiment, a management method and an access method for magnetic disc devices will be described. Positions on the magnetic disc device are managed in units of sectors. System startup information (control information) required for starting up the system is recorded in a sector (e.g., a startup sector, MBR: Master Boot Record) which is read first when the system is started up. Usually, the startup sector is a head sector of a magnetic disc device. The system startup information includes a program called a boot loader, and a partition table containing data indicative of positions of partitions and partition sizes which is read in by executing the boot loader.

Whenever the OS accesses data on a magnetic disc device, the OS needs to obtain, in advance, information required for access to data on the magnetic disc device. Information required for the data access is usually obtained as BIOS executes a boot loader in a head sector when starting up a computer, and as the boot loader reads in a partition table.

If no system startup information exists in the head sector, the OS may not access data on the magnetic disc device and may not be started up. This implies that, when startup of the OS is to be intentionally prevented, proper system startup information may be excluded from the head sector.

Considering the prerequisite described above, the embodiment will now be described. The disc array control device is attached to a system board and is initialized to write system startup information into a sector on the magnetic disc device other than the head sector. The disc array control device also writes data other than the system startup information into the head sector. Further, the disc array control device has a conversion mechanism which converts a head sector number of the magnetic disc device into a sector number of the sector in which the system startup information has been written. In this manner, when the computer is started up, the OS is started up based on the system startup information written in the sector designated by the converted sector number.

By adopting the configuration as described above, the OS is started up when the disc array control device operates normally. However, when the disc array control device is mismounted or causes a malfunction, the system determines that no disc array control device exists. Therefore, when the computer is started up, the BIOS tries to read the system startup information in the head sector. The OS is, however, not started up since there is no system startup information in the head sector. The OS can therefore not access data on the magnetic disc device, and incorrect data is prevented from being erroneously written into the magnetic disc device.

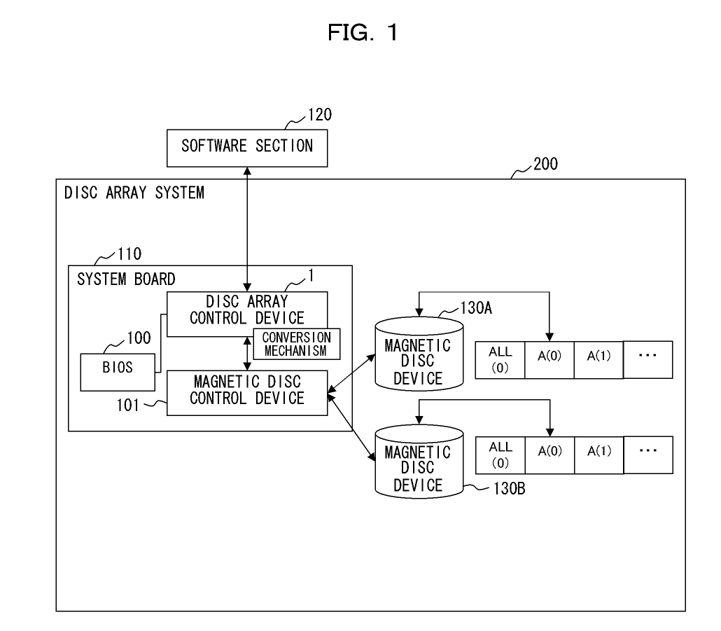

FIG. 1 depicts an example of a configuration of a disc array system including the disc array control device according to the first embodiment.

The configuration of the disc array system will be described with reference to FIG. 1. The disc array system 200 has a system board 110, a magnetic disc device 130A, and a magnetic device 130B (storage devices). Further, the system board 110 has a disc array control device 1 (storage device controlling device), BIOS 100, and a magnetic disc control device 101. The disc array system 200 is provided as a part of a computer.

The system board 110 is a main electronic circuit board (mother board), and mounts devices such as input/output terminals, a CPU, and a memory, which are required to operate the computer, in addition to the disc array control device 1, the BIOS 100, and the magnetic disc control device 101.

The magnetic disc device 130A and the magnetic disc device 130B (which will be hereinafter referred to as “magnetic disc devices 130A and 130B” where both magnetic disc devices are expressed) are hard disc drives, and are duplexed by the disc array control device 1. That is, the magnetic disc devices 130A and 130B store the same data. The magnetic disc devices 130A and 130B, which are built in the computer in the first embodiment, may be external magnetic disc devices. The magnetic disc devices may be connected in a connection form of IDE (Integrated Drive Electronics), SCSI (Small Computer System Interface), or any other connection form.

The BIOS 100 is a program which is executed immediately after starting up the computer. The BIOS 100 controls devices in the computer and provides a software section 120 with a function to control the devices.

The magnetic disc control device 101 controls data inputted to or outputted from the magnetic disc devices 130A and 130B.

The disc array control device 1 performs control concerning redundancy of the magnetic disc devices. Further, the disc array control device 1 according to the first embodiment is provided with a conversion mechanism for converting a sector number.

The software section 120 is a set of an OS (Operating System) and application programs which operate on the OS.

When the disc array control device 1 operates normally, access to the magnetic disc devices 130A and 130B from the software section 120 is made through the disc array control device 1 and the disc array control device 1 which are mounted on the system board 110.

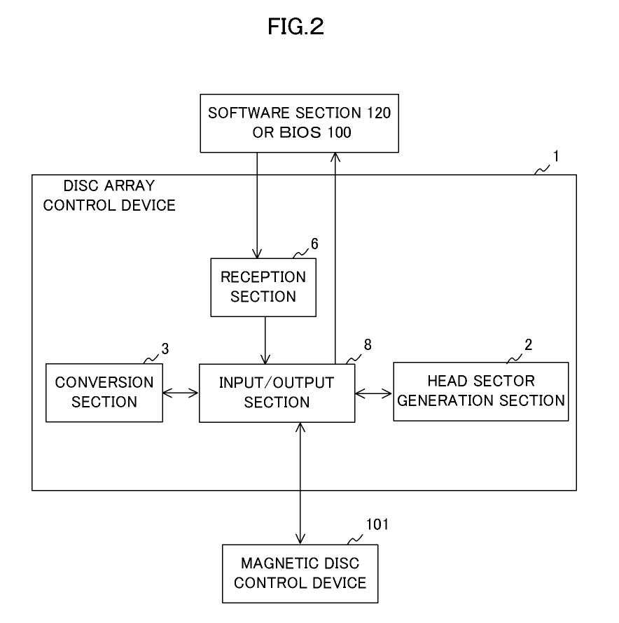

Details of the disc array control device 1 will now be described with reference to FIG. 2. FIG. 2 is a functional block diagram depicting an example of functions of the disc array control device according to the first embodiment.

The disc array control device 1 has a head sector generation section 2, a conversion section 3, a reception section 6, and an input/output section 8.

The head sector generation section 2 generates data of all zero for the head sector in the magnetic disc devices 130A and 1306, as information which is different from system startup information.

The conversion section 3 performs conversion of sector number by adding one to a sector number of the magnetic disc devices 130A and 1306, which is specified by an access request received by the reception section 6.

The reception section 6 receives an access request for access to the magnetic disc devices 130A and 1306 from the software section 120.

The input/output section 8 causes the conversion section 3 to convert a sector number (first sector number) of the magnetic disc devices 130A and 1306, which is designated by the access request received by the reception section 6, and outputs a converted sector number as an access sector number (second sector number) for accessing data to the magnetic disc control device 101. The magnetic disc control device 101 accesses the magnetic disc device 130A and 1306 at the access sector number, through the magnetic disc control device 101. The input/output section 8 writes data of all zero, which is generated by the head sector generation section 2, into the head sector of the magnetic disc devices 130A and 1306 through the magnetic disc control device 101 when initializing the disc array.

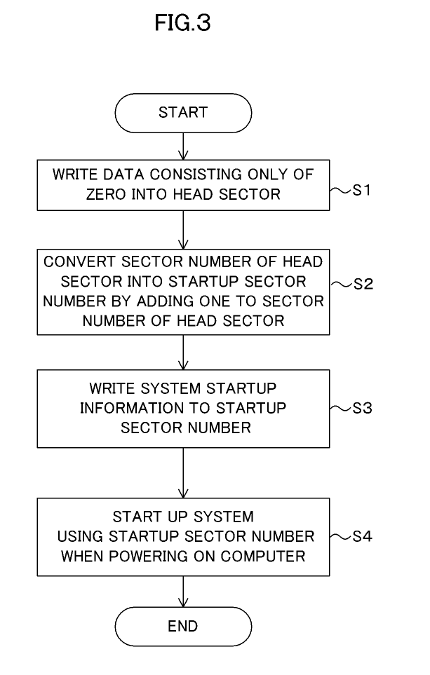

Next, initializing processing in the first embodiment will be described with reference to the flowchart in FIG. 3.

When the reception section 6 receives a request for initializing the disc array from the software section 120, the head sector generation section 2 generates data of all zero (ALL (0)). The input/output section 8 writes the generated data of all zero (ALL (0)) into the head sector of the magnetic disc devices 130A and 1306. The head sector generation section 2 may generate any information insofar as the information is not data of proper system startup information.

Next, the conversion section 3 adds “one” to the sector number of the head sector designated by the access request received by the reception section 6 from the software section 120, thereby to convert the sector number of the head sector into an access sector number (step S2).

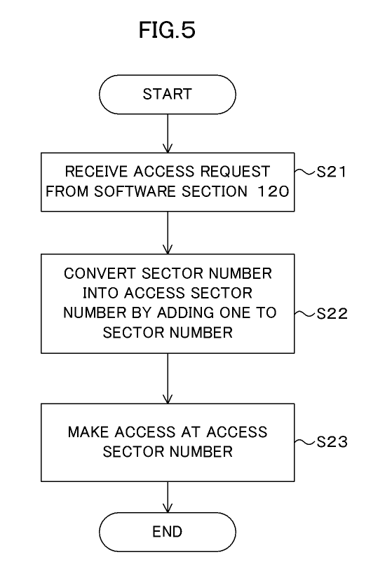

The input/output section 8 writes system startup information received from the software section 120 through the reception section 6, to the access sector number converted by the conversion section 3, and the sector at the access sector number is thereby regarded as a startup sector (step S3). Thereafter, initialization is carried out by writing data in accordance with the same conversion method of adding 1 to sector numbers, as that of sector number conversion processing (see FIG. 5) which will be described later.

FIG. 1 depicts a result of arraying data in the magnetic disc devices 130A and 130B by the initializing processing. The arrays denoted at ALL(0) are head sectors into which duplexed data (A(0), A(1), . . . ) are written, starting from addresses which are not of heads of the magnetic disc devices 130A and 130B. A(0) denotes system startup information.

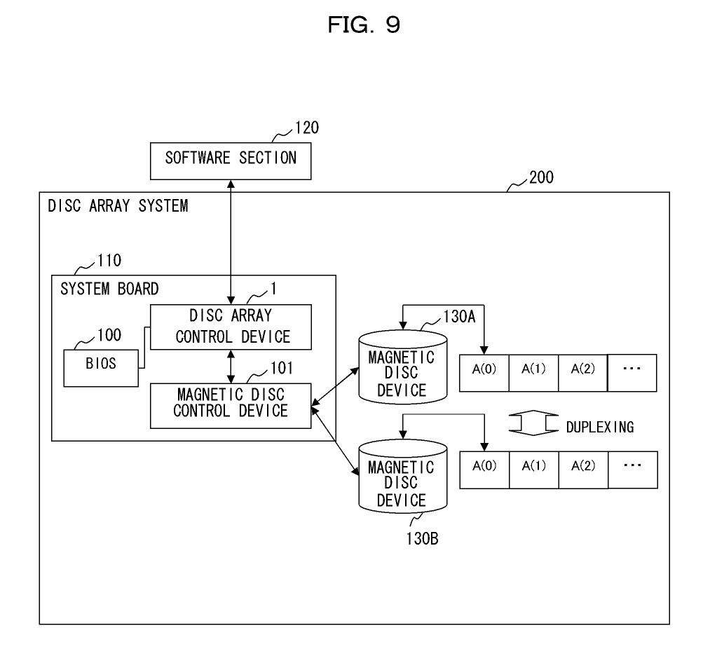

From comparison between the array result in FIG. 1 and a sector array in FIG. 9, data of all zero (ALL(0)) is written in the head sectors (sectors A(0)) in FIG. 9 in the initializing processing. The system startup information denoted A(0) in FIG. 9 is stored in sectors designated by numbers added with one in FIG. 1.

A sector number which is designated for the magnetic disc devices 130A and 130B subjected to the processing described above by an access request from the BIOS 100 when starting up the computer afterwards is added with one by the conversion section 3 and is then regarded as an access sector number. The input/output section 8 makes access at the access sector number through the magnetic disc control device 101, and the system is thereby started up (step S4).

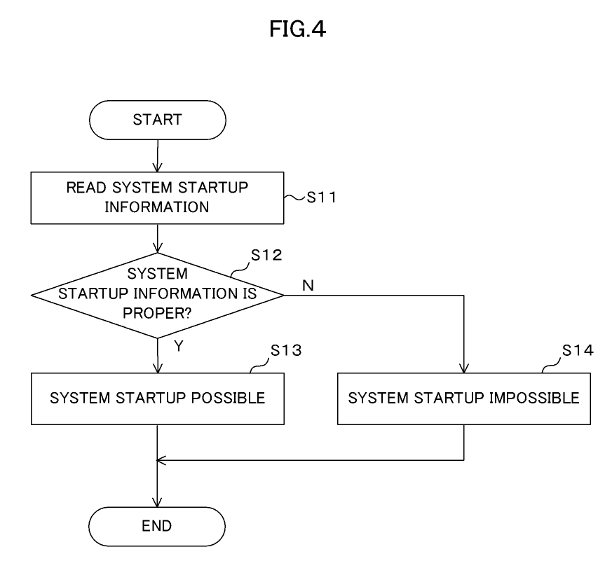

Next, startup processing of the disc array control device 1 in a normal state and in an abnormal state will be described with reference to a flowchart in FIG. 4. The BIOS 100 reads system startup information immediately after startup of the computer (step S11). If the system startup information is proper information (step S12, Y), the disc array control device 1 is recognized as operating normally. Although the BIOS 100 recognizes that the system startup information is read from a head sector, the system startup information stored at an access sector number which is obtained by adding one to a head sector number through the conversion processing in the conversion section 3 as described above is actually read. The BIOS 100 is capable of normally starting up the OS (step S13).

Meanwhile, if the disc array control device 1 causes a malfunction (or a poor contact), the conversion processing is not carried out by the conversion section 3, and the BIOS 100 therefore reads directly the head sector. However, as the head sector consists of data of all zero as described previously, the BIOS 100 hence determines the system startup information to be improper (step S12, N). Therefore, the BIOS 100 can use neither the magnetic disc device 130A nor 130B, and can therefore not start up the OS (step S14). As a result, access such as data writing to the magnetic disc device 130A does not take place as access takes place to only one magnetic disc device because no disc array is constructed, and accordingly, data consistency can be maintained between the magnetic disc devices 130A and 130B.

Next, in order to store data, the software section 120 needs to access to the magnetic disc devices 130A and 130B in which sector numbers have been converted by the conversion section 3 as described previously, after starting up the OS. A flowchart in FIG. 5 depicts sector number conversion processing at the time of this access to input/output data.

The reception section 6 receives an access request from the software section 120 (step S21). The conversion section 3 converts the sector number designated by the access request received by the reception section 6, into an access sector number by adding one to the sector number (step S22). The input/output section 8 accesses the magnetic disc devices 130A and 130B at the access sector number converted by the conversion section 3, through the magnetic disc control device 101 (step S24).

For example, if the software section 120 requests data writing at a sector number “1000”, the reception section 6 receives the access request, and adds one to the sector number “1000” designated by the access request, to obtain an access sector number “1001”. The input/output section 8 writes data into the sector designated by the sector number “1001” in both the magnetic disc devices 130A and 130B, through the magnetic disc control device 101.

The conversion method for converting sector numbers, by the conversion section 3 according to the first embodiment, is a method of adding one to each sector number. However, the numerical value to be added need not be one, but may be any numerical value insofar as sector numbers after conversion do not exceed the number of sectors in the magnetic disc devices. The conversion method may be any method insofar as data is not written into the head sector by the method and sector numbers before conversion one-to-one-correspond to sector numbers after conversion.

In the first embodiment, the head sector generation section 2 outputs data of all zero for the head sector. The disc array system 200 can further notify users of occurrence of a trouble in the disc array control device 1, by outputting a preset code for outputting an arbitrary error message to the head sector to perform error processing. That is, the head sector generation section 2 outputs a code for outputting an arbitrary error message in place of outputting data of all zero through the processing in step S1. The input/output section 8 writes the code into a region where a boot loader for a head sector has been written. In this manner, the BIOS 100 which has read the head sector can output an error message, if the disc array control device 1 causes a malfunction. In place of the error message, an error notification using a beep or any type of error processing is available.

If a malfunction occurs in the disc array control device 1 while the OS is operating, the system goes down at that moment, and the OS never starts up when the computer is started up thereafter, as described above. Accordingly, no disc access occurs also in a case that a malfunction occurs in the disc array control device 1 while the OS is operating.

According to the first embodiment, unless the disc array control device 1 operates normally, data in the magnetic disc devices 130A and 1306 may not correctly be recognized, and may not be accessed from the software section 120. That is, data is not updated in either of the magnetic disc devices, and data errors do not occur after recovery of the disc array control device.

### Second Embodiment

In the first embodiment, the conversion method of the conversion section 3 is to add one to sector numbers. A second embodiment adopts, as the conversion method, a method based on an encryption algorithm and converts the sector numbers.

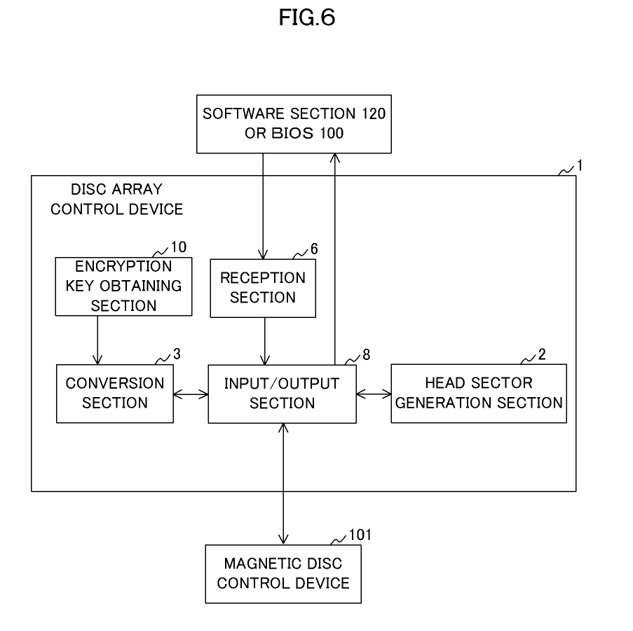

A disc array system according to the second embodiment basically has the same configuration as the first embodiment. FIG. 6 is a functional block diagram of a disc array control device according to the second embodiment. In the second embodiment, the disc array control device 1 has an encryption key obtaining section 10 which obtains an encryption key from a user. Reference symbols which are common to FIGS. 6 and 2 denote the same components as or equivalents to components depicted in FIG. 2, which will be therefore omitted from descriptions made below.

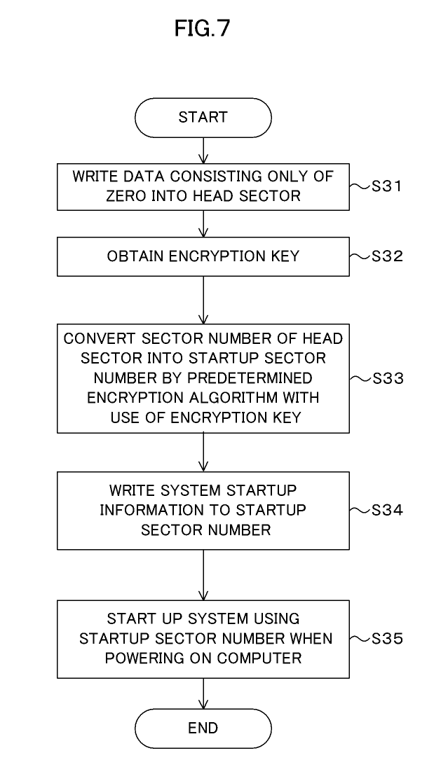

FIG. 7 is a flowchart of initializing processing in the second embodiment. In the second embodiment, the disc array control device 1 is attached to the system board 110, and the initializing processing is executed when initializing the disc array control device 1, as in the first embodiment.

Processing in step S31 is the same as that in step S1 in the first embodiment (see FIG. 3) and will therefore be omitted from descriptions made below.

The encryption key obtaining section 10 obtains an encryption key from a user (step S32). The encryption key obtaining section 10 may obtain, as the encryption key, a setting of a DIP switch which is physically provided on the disc array control device 1 or a setting of a POST screen displayed on the disc array control device 1. The same effect can be obtained by any method other than a method described above of obtaining the encryption key. The obtained encryption key is stored in a not-depicted non-volatile memory of the disc array control device 1.

Next, using the encryption key obtained by the encryption key obtaining section 10, the conversion section 3 converts the sector number of the head sector into an access sector number, based on predetermined encryption (step S33). The encryption may be of any method insofar as no data is written into the head sector and sector numbers before conversion one-to-one-correspond to sector numbers after conversion.

Subsequent processing (steps S34 and S35) is the same as that in the first embodiment (see FIG. 3), and will therefore be omitted from descriptions made below.

Startup processing of the disc array control device 1 in normal and abnormal states is the same as that in the first embodiment (see FIG. 4), and will therefore be omitted from descriptions made below.

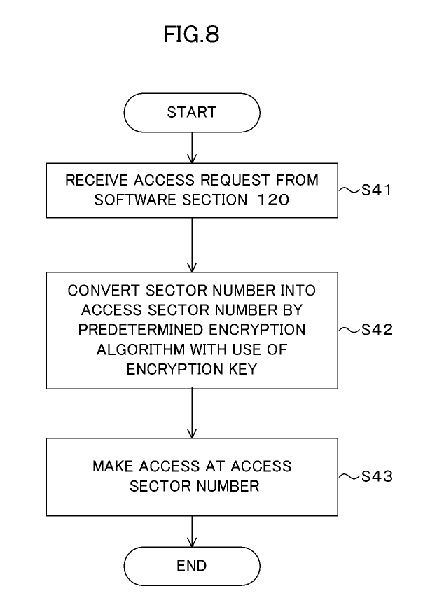

Next, FIG. 8 is a flowchart of sector number conversion processing in the second embodiment. Processing in steps S41 and S43 is the same as that in the first embodiment (see FIG. 5), and will therefore be omitted from descriptions made below.

The conversion section 3 converts a sector number designated by an access request received by the reception section 6 into an access sector number, based on a predetermined encryption algorithm, by using an encryption key obtained by the encryption key obtaining section 10, wherein the encryption key has already been obtained in step S31 which has been executed at the time of initializing the disc array control device 1 (step S43). The encryption may be of any method insofar as no data is written into the head sector and sector numbers before conversion one-to-one-correspond to sector numbers after conversion.

The conversion section 3 in the second embodiment performs conversion according to an encryption algorithm using an encryption key obtained by the encryption key obtaining section 10. However, an encryption algorithm using no encryption key may also be used.

According to the second embodiment, access is impossible if the magnetic disc devices 130A and 130B are carried out of the disc array system. Therefore, leakage of data on the magnetic disc devices 130A and 130B can be prevented. Even if the magnetic disc control device 1 is replaced due to a malfunction, data on the magnetic disc devices 130A and 130B becomes properly accessible by setting again an encryption key for the magnetic disc devices.

The embodiments have been described above with reference to a magnetic disc control device which controls magnetic disc devices. However, the embodiments are also applicable to a storage device using other storage media such as optical discs or magneto-optical discs.

A head sector writing section corresponds to the head sector generation section 2 and the input/output section 8 in the embodiments. An access section corresponds to the reception section 6, the conversion section 3, and the input/output section 8 in the embodiments.

A head sector writing step corresponds to the processing steps S1 and S31 in the embodiments. An access step corresponds to the processing steps S2 to S4, S21 to S23, S32 to S35, and S41 to S43 in the embodiments.

Further, a program causing a computer, which constitutes a disc array control device, to execute steps described above may be provided in form of a disc array control program. By storing the program into recording media readable by a computer, the program can be executed by a computer which constitutes a disc array control. The recording media readable by a computer include an internal storage device built in a computer, such as a ROM or RAM, portable storage media such as a CD-ROM, a flexible disc, a DVD disc, a magneto-optical disc, or an IC card, a database maintaining a computer program, another computer and a database thereof, and transfer media on lines.

Abnormal operation is prevented from occurring when a storage device controlling device is not recognized.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A storage device controlling device for controlling a storage device having a plurality of storage media, the device comprising:
a head sector write section that writes predetermined information into a head sector on each of the plurality of storage media, the predetermined information being different from control information to be read out first from the plurality of storage media; and
an access section that converts a first sector number indicating a sector on the plurality of storage media into a second sector number indicating a sector other than the head sector, and accesses the plurality of storage media at the second sector number, when an access request is received from outside of the storage device, and the first sector number being designated by the access request.

2. The storage device controlling device according to claim 1, wherein
the predetermined information is a code for executing error processing.

3. The storage device controlling device according to claim 2, wherein
the error processing is to display a predetermined message.

4. The storage device controlling device according to claim 1, wherein
the conversion of the sector number is performed by adding a predetermined numerical value to the first sector number.

5. The storage device controlling device according to claim 1, wherein
the conversion of the sector number is performed by subjecting the first sector number to predetermined encryption.

6. The storage device controlling device according to claim 5, further comprising
an encryption key obtaining section that obtains an encryption key, wherein
the conversion of the sector number is performed by subjecting the first sector number to encryption using the encryption key obtained by the encryption key obtaining section.

7. The storage device controlling device according to claim 1, wherein,
when initializing the plurality of storage media, the access section takes the first sector number as a second sector number of the head sector, and writes the control information to a second sector number obtained from the first sector number.

8. The storage device controlling device according to claim 7, wherein,
when starting up the storage device controlling device, the access section takes the first sector number as a sector number of the head sector, and reads the control information from the second sector number obtained from the first sector number.

9. A computer-readable medium having recorded thereon a storage device controlling program, which when executed by computer, causes the computer to execute a process comprising:
writing predetermined information into a head sector on each of a plurality of storage media in a storage device, the predetermined information being different from control information to be read out first from the plurality of storage media;
converting a first sector number as a sector number on the plurality of storage media into a second sector number as a sector number other than that of the head sector on the plurality of storage media, based on a predetermined conversion method, and accessing the plurality of storage media at the second sector number, the first sector number being designated by the access request, if an access request is received from outside.

10. The computer-readable medium according to claim 9, wherein
the predetermined information is a code for executing error processing.

11. The computer-readable medium according to claim 9, wherein
the conversion method is to obtain the second sector number by adding a predetermined numerical value to the first sector number.

12. The computer-readable medium according to claim 9, wherein
the conversion method is to obtain the second sector number by subjecting the first sector number to predetermined encryption.

13. The computer-readable medium according to claim 12, wherein
the storage device controlling program further causes a computer to execute a step that obtains an encryption key, and
the conversion method is to obtain the second sector number by subjecting the first sector number to encryption using the obtained encryption key.

14. The computer-readable medium according to claim 9, wherein
the storage device controlling program further causes a computer to execute a step that, when initializing the plurality of storage media, takes the first sector number as a second sector number of the head sector, and writes the control information to a second sector number obtained from the first sector number.

15. A storage device controlling method comprising:
writing predetermined information into a head sector on each of a plurality of storage media in a storage device, the predetermined information being different from control information to be read out first from the plurality of storage media;
converting a first sector number indicating a sector on the plurality of storage media into a second sector number indicating a sector other than the head sector on the plurality of storage media, when an access request is received from outside of the storage device, and the first sector number being designated by the access request; and
accessing the plurality of storage media at the second sector number.

16. The storage device controlling method according to claim 15, wherein
the predetermined information is a code for executing error processing.

17. The storage device controlling method according to claim 15, wherein
the second sector number is obtained by adding a predetermined numerical value to the first sector number.

18. The storage device controlling method according to claim 15, wherein
the second sector number is obtained by subjecting the first sector number to predetermined encryption.

19. The storage device controlling method according to claim 18 further comprising:
obtaining an encryption key, and
obtaining the second sector number by subjecting the first sector number to encryption using the obtained encryption key.
